(19) United States
(12) Patent Application Publication
(10) Pub. No.: US 2004/0019557 A1
(43) Pub. Date: Jan. 29, 2004

(54) Method and apparatus for protecting a lender having an interest in a property against a loss

(76) Inventors: Howard Yaruss, Philadelphia, PA (US); Dennis Conway, Houston, TX (US)

Correspondence Address: SCHNADER HARRISON SEGAL & LEWIS, LLP, 1600 MARKET STREET, SUITE 3600, PHILADELPHIA, PA, 19103

(21) Appl. No.: 10/208,128

(22) Filed: Jul. 29, 2002

(51) Int. Cl. G06F 17/60

(52) U.S. Cl. 705/38

(57) ABSTRACT

The invention relates to a system for protecting a lender, having a security interest in a real property against a loss arising in default by a borrower on a loan therefor, which includes covering the lender under a mortgage guaranty insurance policy to provide financial compensation for a portion of the loss independently of the reason for the default; and providing a separate monetary limit for loan defaults involving one or more undisclosed liens on the property that secures the loan; causing the loan to be generated between a lender and a borrower for a portion of the value of the property, which is associated with the policy to trigger the policy in the event of a default on the loan; and requiring that a loan related search be conducted prior to covering of the property under the policy, including reviewing both borrower related information and property related information.

### BACKGROUND

1. Field of the Invention

The invention is directed to a method and apparatus for protecting a lender having a security interest in a property against a financial loss. Particularly, the invention is directed to a method and apparatus for using pooled mortgage guaranty insurance in protecting a lender against a financial loss arising from a default by a borrower on a loan secured by real property.

2. Description of the Prior Art

In loan transactions for the refinancing of real property or obtaining a second mortgage thereon, borrowers are often surprised at the high closing costs associated with completing the transaction. In order to obtain the loan from a lender, the borrower is often times required by the lender to obtain and pay for a number of items, including various types of insurance that protect the interest of the lender, such as title insurance and mortgage guaranty insurance. Moreover, the complexity of the transaction often limits the manner and location in which settlement can occur, and greatly increases the cost of the transaction.

Many lenders require title insurance as security for their investment in real estate, just as they may call for fire insurance and other types of coverage, such as mortgage guaranty insurance, as investor protection. A required part of obtaining title insurance is a search of public land records for matters affecting the title to the real estate. The examination of evidence from a search is intended to fully report all material objections to the title. Frequently, instruments that don't clearly pass title are found in the chain, or history, of ownership assembled from the records in a search. These need to be corrected before a clear title can be conveyed. Some examples of instruments that can present concerns and create encumbrances on the property are other deeds, wills, and trusts that contain improper vestings and incorrect names; outstanding mortgage liens, judgment liens, tax liens; easements; and incorrect notary acknowledgments.

Through the search and examination, title problems of this type are disclosed so they may be cured whenever possible. However, hidden hazards can also emerge after completion of a real estate purchase. Some examples include the following: a forged deed that transfers no title to real estate; previously undisclosed heirs with claims against the property; instruments executed under expired or fabricated power of attorney; and mistakes in the public records.

Title insurance offers the lender financial protection against undisclosed and undiscovered encumbrances on the property through negotiation by the title insurer with third parties, payment for defending against an attack on title as insured, and payment of claims. Its primary purpose is to cure defects in title.

Title insurance policies are typically written on a per transaction basis, after the complex and costly research procedure discussed above has been performed. Typically, both the owner (borrower) and the lender obtain title insurance on a home purchase transaction. The lender's policy is paid for by the borrower or by the seller of the property.

Consequently, alternative, less time consuming and expensive systems have been proposed whereby the organization conducting the aforementioned research would provide a warranty against errors and omissions made pursuant to this research, which would protect the owner of an interest in the property, such as the lender or the borrower, against a loss due to an error or omission in the search. However, these systems still had disadvantages, in that, for example, coverage provided against the loss, or a portion of the loss, was not independent of the nature of the loss, e.g., the loss must have arisen from an error or omission in the search.

In addition to title insurance, lenders also typically require mortgage guaranty insurance for the mortgage loan on the property to protect against loss by providing financial compensation in the event of borrower default. In sharp contrast to a title insurance policy, a mortgage guaranty insurance policy protects a lender only from a financial loss that may arise if the borrower defaults, which is independent of the nature of the loss, such as if it is damaged or destroyed, is uninhabitable and can no longer be used, or there is simply a drop in market value. In other words, the policy covers the lender if the lender suffers financial loss arising from the borrower's default on the mortgage loan, regardless of the reason for the financial loss.

Mortgage guaranty insurance offers protection to the lender from financial loss due to borrower default, typically triggered upon a default and subsequent sale of the property for less than the amount of the loan or mortgage. Unlike title insurance, its primary purpose is to protect the lender from the risk of default.

While individual mortgage guaranty insurance policies may be written on a per transaction basis, larger insurers and guarantors often provided a pooled mortgage guaranty insurance policy to and among the lenders with which it does regular business. Protection for individual loan transactions is provided by registering the loan under the pool policy.

Often, particularly in the case of a second mortgage, a refinance or a home equity loan, many of the closing costs typically associated with completing a loan for a purchase transaction are largely unnecessary, such as a new title search and title insurance policy. In the case of both a second mortgage, where the lender is in a junior position on the title, and a refinance, a complete title search and title insurance policy were probably completed only a few years before at the time the borrower purchased the property. Consequently, the risk of loss due to title defects other than undisclosed or undiscovered liens is very low and the additional expense of a new title search and title insurance policy is unwarranted.

Accordingly, a system is needed whereby the complexity and cost of a closing for a loan for real property can be significantly reduced by streamlining portions of the closing process and eliminating the need for a title search and title insurance policy by using the coverage afforded by an insurance policy that protects the lender and owner of an interest in a property against a financial loss arising from a borrower's default, including a loss that is independent of the nature of the default.

### SUMMARY OF THE INVENTION

The invention is directed to a method for protecting a lender having a security interest in a real property against a loss arising from a default by a borrower on a loan for the property, which includes covering the party under a mortgage guaranty insurance policy to provide financial compensation for a portion of the loss arising from the default, independently of the reason for the default; and providing a separate monetary limit for loan defaults involving one or more undisclosed liens on the property that secures the loan. The invention may further include causing the loan to be generated between the lender and the borrower for at least a portion of the value of the property, which is associated with the insurance policy to trigger the policy in the event of a default on the loan; and requiring that a loan related search be conducted prior to covering of the property under the policy, the loan related search including a review of both borrower related information and property related information.

The invention is also directed to an apparatus comprising a means for covering the lender under a mortgage guaranty insurance policy to provide financial compensation for at least a portion of the loss arising from the default independently of the reason for the loss; and providing a separate monetary limit for loan defaults involving one or more undisclosed liens on the property that secures the loan.

### BRIEF DESCRIPTION OF THE DRAWINGS

FIG. 1 is a block diagram illustrating a preferred embodiment of the invention used over the Internet.

FIG. 2 is a computer screen shot of a login screen in accordance with aspects of the invention.

FIG. 3 is a computer screen shot of a current order form in accordance with aspects of the invention

FIGS. 4(a)-(c) are computer screen shots of an order submission form in accordance with aspects of the invention.

FIGS. 5(a)-(b) are computer screen shots of an order details form in accordance with aspects of the invention.

FIG. 6 is a computer screen shot of order status form in accordance with aspects of the invention.

FIG. 7 is a computer screen shot of a documents form in accordance with aspects of the invention.

FIGS. 8(a)-(c) are computer screen shots of a report in accordance with aspects of the invention.

### DETAILED DESCRIPTION

The invention will be understood more fully from the detailed description given below and from the accompanying drawings of preferred embodiments of the invention; which, however, should not be taken to limit the invention to a specific embodiment but are for explanation and understanding only.

A preferred embodiment of the invention is directed to a computerized system and method of providing protection to a lender against financial loss in the event of a default by the borrower on a loan for a property, including a loss involving an undisclosed lien on the property, using an alternative to title insurance; and to provide information related thereto that can be used in connection with loans associated therewith, such as refinances, second mortgages, and home equity loans. This embodiment incorporates the use of an insurance policy that covers against financial loss independently of how the loss occurred, such as a mortgage guaranty insurance policy, preferably written by at least an AA-rated mortgage guaranty insurance company. The preferred embodiment provides a layer of insurance coverage to a lender for a wide range of losses arising from a borrower's default under a covered loan, including preferably providing a separate monetary limit for loan defaults involving one or more undisclosed liens on the property that secures the loan.

The terms “computer”, “computer system”, or “server” as used herein should be broadly construed to include any device capable of receiving, transmitting and/or using information including, without limitation, a processor, microprocessor or similar device, a personal computer, such as a laptop, palm PC, desktop, workstation, or word processor, a network server, a mainframe, an electronic wired or wireless device, such as for example, a telephone, an interactive television, such as for example, a television adapted to be connected to the Internet or an electronic device adapted for use with a television, a cellular telephone, a personal digital assistant, an electronic pager, a digital watch and the like. Further, a computer, computer system, or system of the invention may operate in communication with other systems over a communication network, such as, for example, the Internet, an intranet, or an extranet, or may operate as a stand-alone system.

The invention may be implemented through the use of a computer network, such as the Internet, and more particularly, the World Wide Web (the “Web”). While the invention disclosed herein depicts a preferred embodiment of the invention as deployed over the Internet using a Web browser, those of ordinary skill in the art will appreciate that the invention is not limited thereto and may be deployed using other means computer-based or otherwise, such as for example, thin client applications, and may be deployed over a closed network, Virtual Private Network, and any other securable or unsecurable intemetworked system.

The Web allows users to interact with each other and access content through a graphical user interface, or “GUI.” The most commonly used GUI's are Web browsers, which are software applications that allow users to access and view electronic documents in a browser window. Web documents are created using Hypertext Markup Language (“HTML”), which allows authors to add special format tags to plain text documents to control the appearance of the text in the Web browser. HTML tags also allow for the insertion of additional components into the Web document, such as image files, audio files, and applets. Applets are small pieces of programming code that are run on the user's computer when downloaded. Applets allow for such effects as scrolling text and animation, and for use in the secure transfer of information across the Internet. To enhance security, an information server may use Secure Socket Layer (“SSL”) technology, which is widely known by those skilled in the art and is integrated into most commercially acceptable Web browsers. One of ordinary skill in the art will appreciate that other, similar technology is also capable of being used in the invention, such as, for example, Visual Basic, Java/Java script, Active Server Pages (“ASP”), extensible Markup Language (“XML”), and Simple Object Access Protocol (“SOAP”).

The following is a description of the information collection and provisioning system aspect of the invention. In a preferred embodiment of the invention (although not limited thereto), information is submitted and provided over the Internet, such as through the use of a series of HTML forms, to and from an information server, which stores this information in a data source. The information to be transmitted, as described below, may be in the form of e-mail, Web pages, text files, or any other conventional electronic format capable of conveying information over a communication network. The operation of these media in transmitting information are well known to those of ordinary skill in the art, and will not be further elaborated upon here.

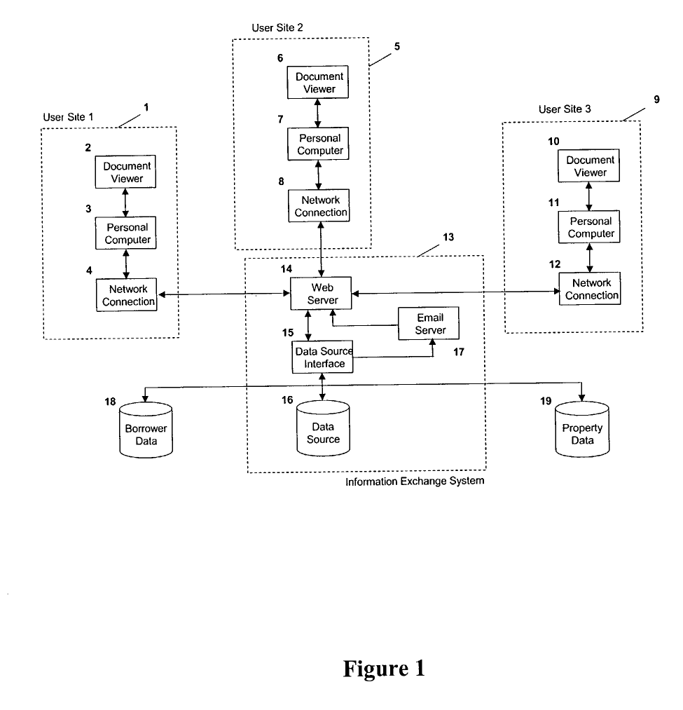

FIG. 1 is a simplified diagram demonstrating the typical components used in an embodiment when used over the Internet. In this example, there are a plurality of User Sites (1, 5, 9), which may be located, for example, at offices of a lender, or at a borrower's home or office. An electronic document, such as a Web page created using HTML and/or ASP, is loaded into a Document Viewer (2, 6, or 10) by a user. The document viewer may be any software application capable of viewing electronic documents and loading additional electronic documents from within the original document, such as through the use of a hypertext link (although not limited thereto). For example, the document viewer may include a Web browser, such as Navigator from Netscape Communications or Microsoft's Internet Explorer. The electronic document may be loaded automatically when the document viewer is first started, or may be opened into the viewer by the user from a file stored locally or at a remote URL. For example, the user may load the document by typing the document's URL into the Web browser's command line.

Document Viewer (2, 6, or 10) may be accessed by the user through any of a number of computer systems, such as through the use of a terminal connected to a mainframe system, from a personal computer, or over a computer connected to a local computer network or the like.

Document Viewer (2, 6, or 10) is connected to the Internet along with other document viewers and computers, such as Personal Computer (3, 7, or 11) through Network Connection (4, 8, or 12). This connection is typically made through local telephone lines using an analog, ISDN, or DSL modem, although it can be over a direct network connection, such as an Ethernet network, for example. The administrator of the network connection (e.g. an Internet Service Provider or “ISP”) maintains a computer network that routes requests from the document viewer to the appropriate location on the Internet, for example. This is accomplished in a conventional manner, such as through the use of a modem pool connected to a local server and Internet gateway (not shown). Information is transmitted over the Internet using the TCP/IP protocol. With this protocol, each location on the Internet, typically a specific computer or Web server, has its own unique IP (Internet Protocol) address. This address identifies where the computer or server is located on the network. The network connects the document viewer to Information Exchange System 13 through any of a number of well-known connection schemes, such as through the use of leased lines. Information Exchange System 13 may comprise Web Server 14, Data Source Interface 15, Data Source 16, and Email Server 17, the operation and interrelation of which is described in more detail below.

After a Web document is loaded into the document viewer, the document viewer waits until the hypertext link is activated, generating a signal to Web Server 14 in Information Exchange System 13. This is preferably in the form of an HTTP request sent over the Internet using TCP/IP and SSL. The HTTP request may include a request for stored information, a submission of information, or both. It will be appreciated that the details of HTTP operation in conjunction with TCP/IP are well known to those of ordinary skill in the art and will, therefore, not be elaborated on here.

Web Server 14 may be a software application running on a remote computer that is capable of forwarding or processing HTTP requests from each document viewer. For example, Web Server 14 may include any one of a number of well-known server applications, such as any NSCA based Web server, the Apache Web server, or the like. When the HTTP request is received by Web Server 14, Web Server 14 accesses Data Source 16 using Data Source Interface 15 to retrieve any requested information, or to submit information, based upon signal from the document viewer. In one embodiment of the invention, Web Server 14 receives the HTTP request from Document Viewer (2, 6, 10), parsing the request to determine the desired information.

The requested information is preferably accessed in Data Source 16 by using a common gateway interface (“CGI”), well known to those of skill in the art, as Data Interface 15. This program acts as an interface between the server and the data source by executing a set of instructions based upon the information received by the server in the HTTP request and passed by the server to the CGI program. The CGI program can take a number of forms which are well known in the art, such as PERL scripting, C++ modules, Visual Basic or other common programming languages. It may also comprise, for example, an Application Program Interface (“API”) or a suite of database tools or objects associated with Data Source 16.

The CGI program may extract the document location information, e.g. the URL, from the information passed to it by Web Server 14 and retrieve a record or records from Data Source 16. Conversely, it may also submit information as well. This may be accomplished in a number of ways. For example, if the CGI program is a PERL script, a database access module, can be used in connection with a number of database packages, such as to interface with the majority of commercial relational database applications, which may comprise Data Source 16. Examples of such databases include Oracle, Sybase, SQL Server, Microsoft Access, and the like. The interaction of Web servers, CGI programs, and data sources and the sending of information there between is well known to those of ordinary skill in the art.

The above-described system may be used in the invention, for example, to provide information related to a loan transaction to be associated with an insurance policy, such as a mortgage guaranty insurance policy or a pooled mortgage guaranty insurance policy where the loan is registered under the pooled policy, wherein the insurance policy allows for loss coverage based upon credit losses including losses involving undisclosed liens on the property securing the loan. This insurance policy is preferably limited to refinance loans, home equity loans, and second mortgages. Preferably, the insurance policy has certain eligibility criteria. It is preferred that the loan-to-value (LTV), or combined-loan-to-value (CLTV), ratio be no more than 100% on loans up to about $650,000. The eligible property types preferably include single units, attached and detached, existing property, and primary and secondary homes.

Using the system of the invention, the lender submits loan information for the loan under review. A loan related search is then initiated using this loan related information. The loan related search preferably includes a search of both borrower related information and property related information. The results of this loan related search are then used to generate a mortgage lien report. This mortgage lien report is to be provided to the lender to be used in approving or denying the loan. If the loan is approved, the lender so notifies the insurer, and the approved loan is registered for coverage under the insurance policy.

While the contents of the mortgage lien report are not particularly limited, the report preferably contains easily obtainable borrower related information and property related information that can be used by the lender and the insurer to allow for a prompt evaluation of the insurance coverage and the loan. The report may contain, for example, credit information from the borrower obtained from one or more credit bureaus, such as Trans Union, Experian, and Equifax. This information is available electronically and can be retrieved by Information Exchange System 13 by accessing Borrower Data Source 18 through the use of a variety of methods, examples of which have already been described in connection with Web Server 14, Data Interface 15, and Data Source 16. An ownership verification report is also typically performed and reviewed for the property, but not necessarily included in the mortgage lien report.

The report may also include property related information, such as public property tax lien records, mortgage liens and judgments, and the like. Such information may be maintained, for example, by the appropriate county agency for the county in which the property is located. As with the borrower related information, the property related information may also be retrieved electronically by Information Exchange System 13 by accessing Property Data Source 19 through conventional means.

Once the lender has the report, and an ownership and legal description verification report for the property, the lender then typically obtains a completed application from the borrower along with a borrower's lien affidavit setting forth any liens and other encumbrances known or suspected by the borrower. The lender then compares the report, the borrower's application, and the borrower's affidavit to verify the lien position of the lender when making the loan. Thereafter, the lender ensures that any of the outstanding liens are subordinated to the new mortgage for the loan. Information for the approved loan is then provided to the insurer for registration and coverage under the pooled mortgage guaranty insurance policy.

In a preferred embodiment, while not limited thereto, the coverage of the mortgage guaranty insurance policy is for financial losses paid by the insurer arising from covered loan defaults, subject to a per loan limit of up to $650,000, an aggregate monetary limit for loan defaults involving undisclosed liens on property securing the loan equal to 50 basis points (i.e., 0.50%) of the initial principal balance of the covered loans, and an aggregate limit for loan defaults other than those involving undisclosed liens on property securing the loan equal to 1 basis point of the initial principal balance of the covered loans.

In a preferred embodiment of the invention, the following triggering events must occur in order to make a claim under the policy in regard to an undisclosed lien: 1) the borrower must default on a mortgage loan, 2) a loss is incurred by the mortgage lender as a result of the default, 3) upon default or foreclosure, the lender finds that the lender was in an inferior lien position, and 4) if the lender suffers a loss because of the inferior lien position, the insurer settles the loss of the lender.

The invention may be used regardless of whether the lender is in a senior or junior lien position on the property. The loss coverage under a first or second lien policy may vary, however. For example, under coverage for a first lien, the standard loss calculation, subject to the limit of liability and all other terms and conditions contained in the policy, is preferably the total of the amount of the unpaid principal balance, the amount of the accumulated delinquent interest computed to the date of claim settlement, and the amount of advances made to the lender; less the net proceeds upon an approved sale of the property and any amount received by the lender under a primary mortgage guaranty insurance policy. Under coverage for a second lien, the standard loss calculation, subject to the limit of liability and all other terms and conditions contained in the policy, is preferably equal to the sum of 110% of the unpaid principal balance due under the loan as of the date of default without capitalization of delinquent interest, penalties or advances, less the net proceeds of any sale of the property payable to the lender, and less any amount received by the lender pursuant to any other applicable policy of mortgage guaranty insurance; or the sum of 100% of the unpaid principal balance due under the loan as of the date of default, plus the amount of accumulated delinquent interest computed to the date of claim payment at the loan rate of interest, plus foreclosure costs, including courts costs and reasonable attorney's fees, paid by the lender, less the net proceeds of any sale of the property payable to the lender, and less any amount received by the lender pursuant to any other applicable policy of mortgage guaranty insurance.

In the preferred embodiment of the invention, the loss coverage for a loan default involving an undisclosed lien on the property securing the loan is, subject to the limit of liability and all other terms and conditions contained in the policy, the lesser of the dollar amount of any valid undisclosed lien that takes priority over the lien position under the policy or the appropriate first or second lien standard loss calculation set forth above.

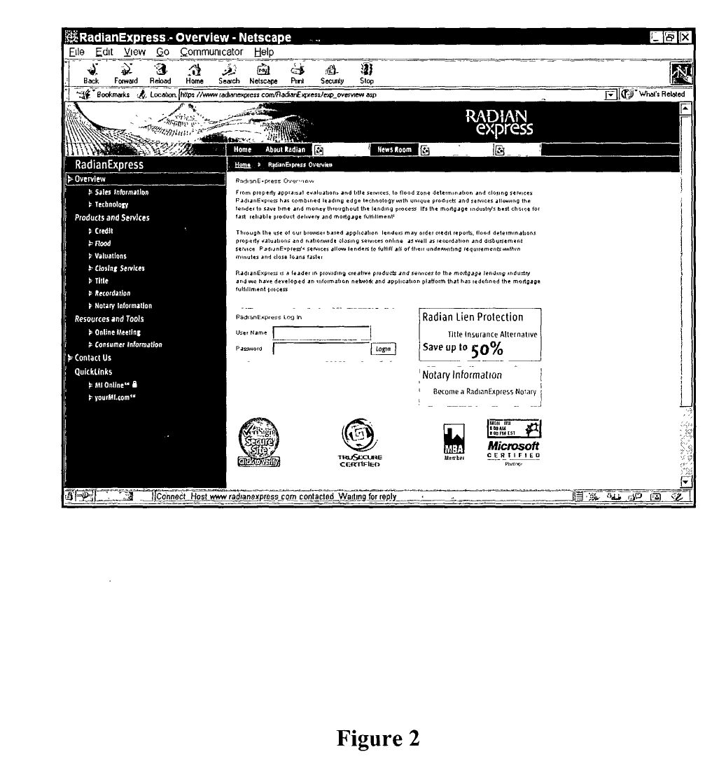

The operation of the system is further illustrated in FIGS. 2-6. FIG. 2 is a computer screen shot of a login screen for the Web site of the system. In order to access Information Exchange System 13, the lender or borrower preferably has an account on the system, which is protected by a user name and password in a conventional manner.

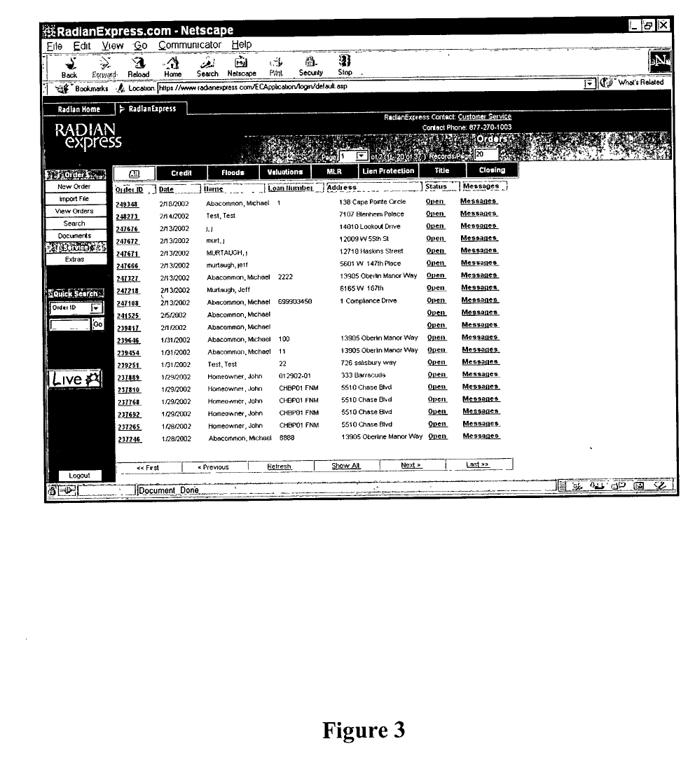

After supplying the proper user name and password, the user logs into Information Exchange System 13, where the current order form is provided, an example of which is shown in FIG. 3. The current order form preferably contains a listing of information on current orders that are stored in Data Source 16 of Information Exchange Server 13 and retrieved there from by Data Interface 15, and served to the user by Web Server 14 in a conventional manner. Orders are preferably assigned an Order ID by which they can be uniquely identified and tracked in the system. The date of origination for the order is preferably provided, as well as the name of the borrower, the loan number, the borrower's address, and the status of the order. In this example, a link is also provided to any messages that have been sent between the lender and the insurer and vice versa. Navigational icons may also be provided, as shown.

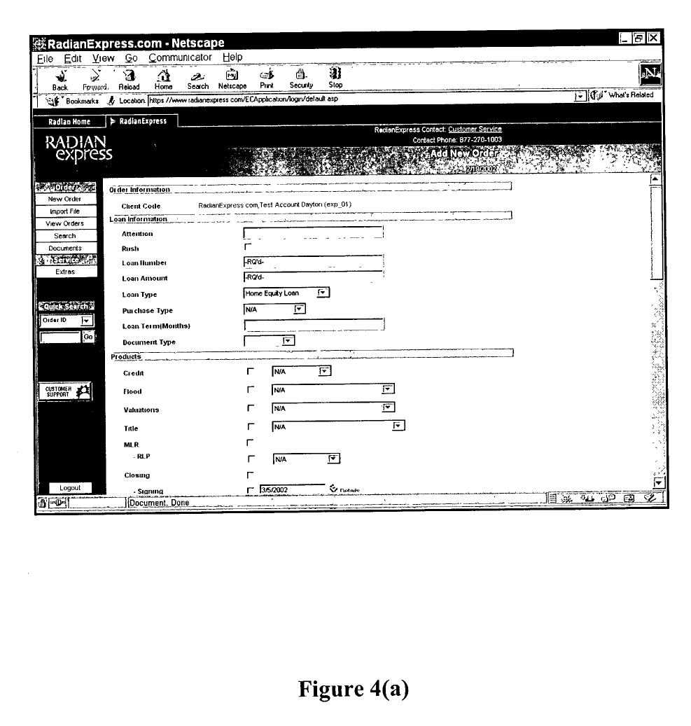

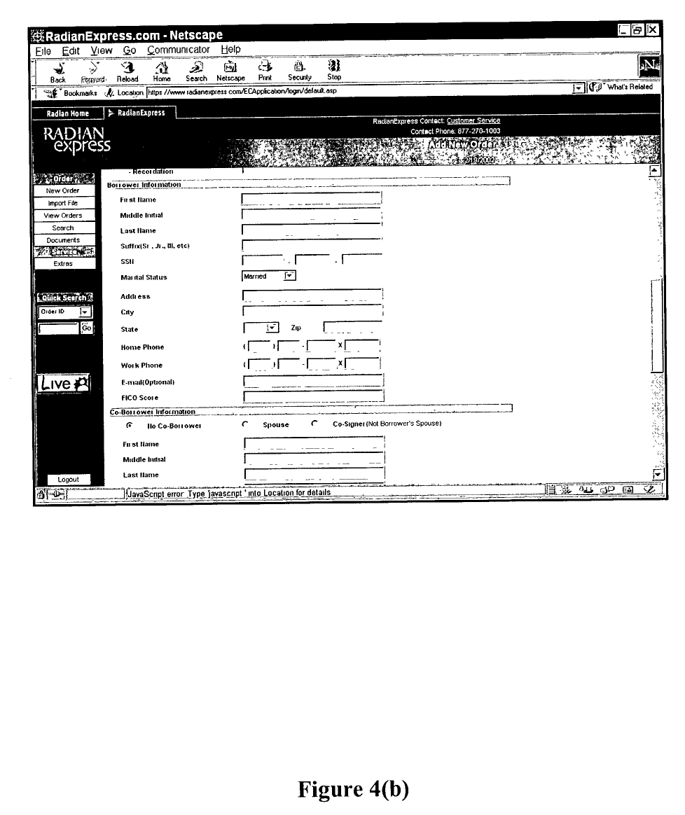

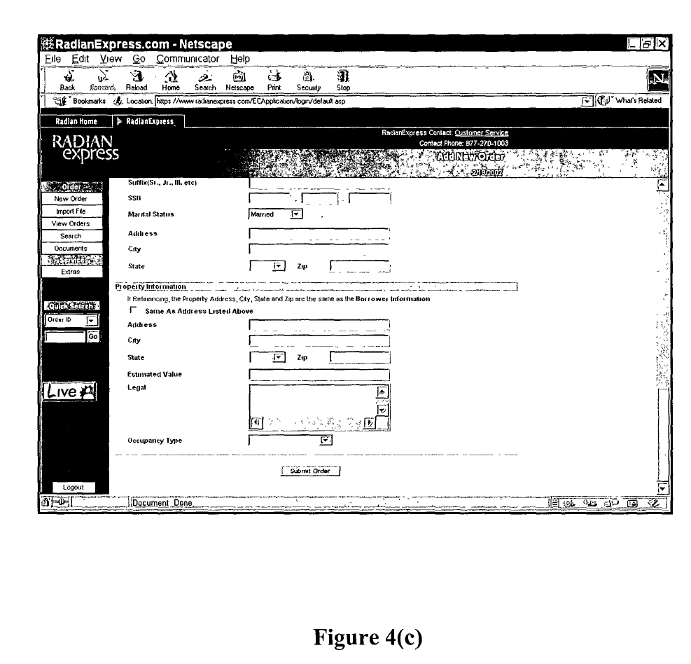

To submit loan related information as a new order, the lender preferably clicks on the new order icon. This retrieves the order submission form, shown in FIGS. 4(a)-(c). As shown in FIGS. 4(a)-(c), the lender is prompted to provide loan related information, such as the loan number, the loan amount, the loan type (e.g., rate/term refinance, cash-out refinance, home equity loan, or home equity line of credit—HELOC), the purchase type (e.g., conventional, FHA, or VA), the term of the loan, and the documentation required for the loan (e.g., full or partial). The lender is also prompted to select the products to be ordered, which may include a mortgage lien report and mortgage guaranty insurance, an appraisal/valuation, credit search, flood report, title search, title recordation, and the like. Borrower information is also requested, for example, the borrower's name, address and social security number. Finally, information on the property is requested, such as the address, estimated value, and occupancy type (e.g., primary residence, secondary residence, or investment property).

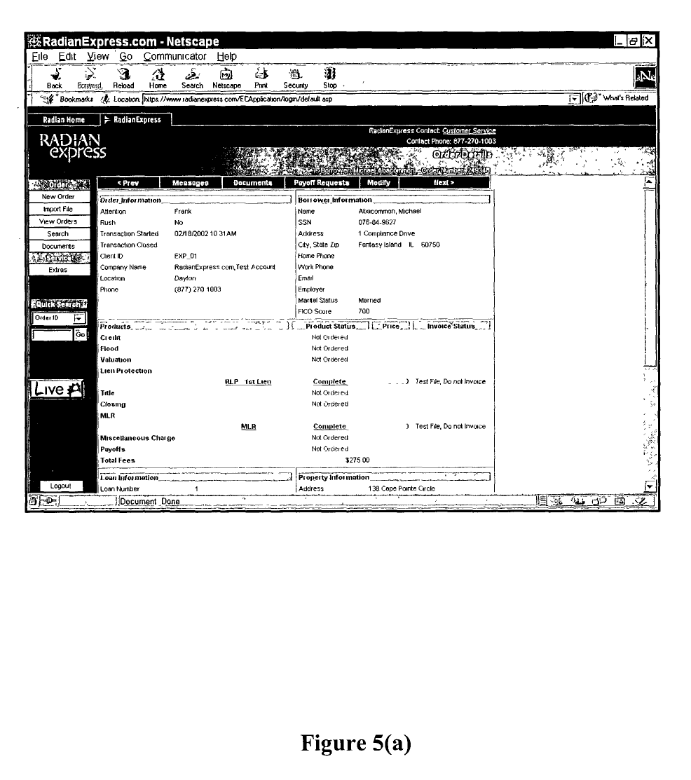

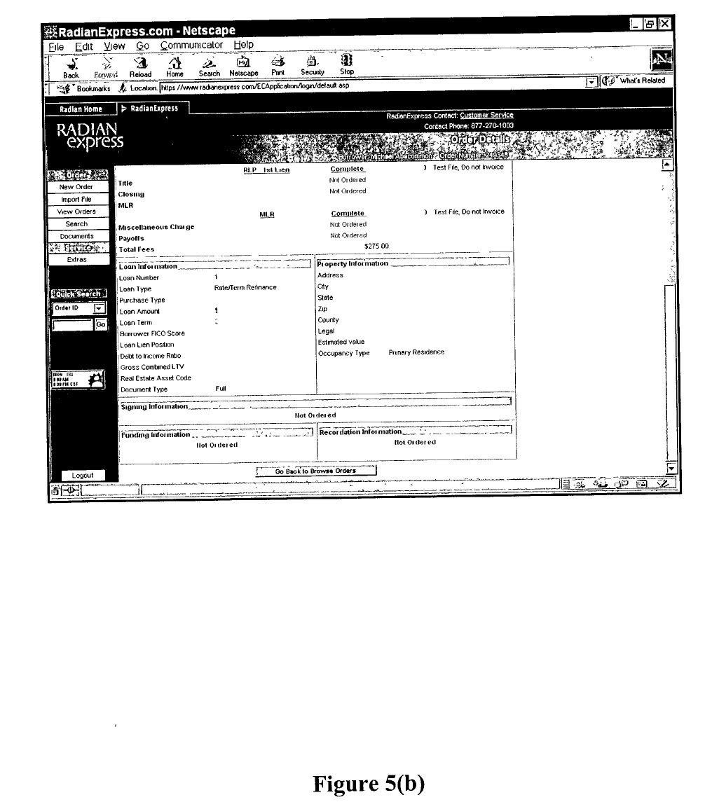

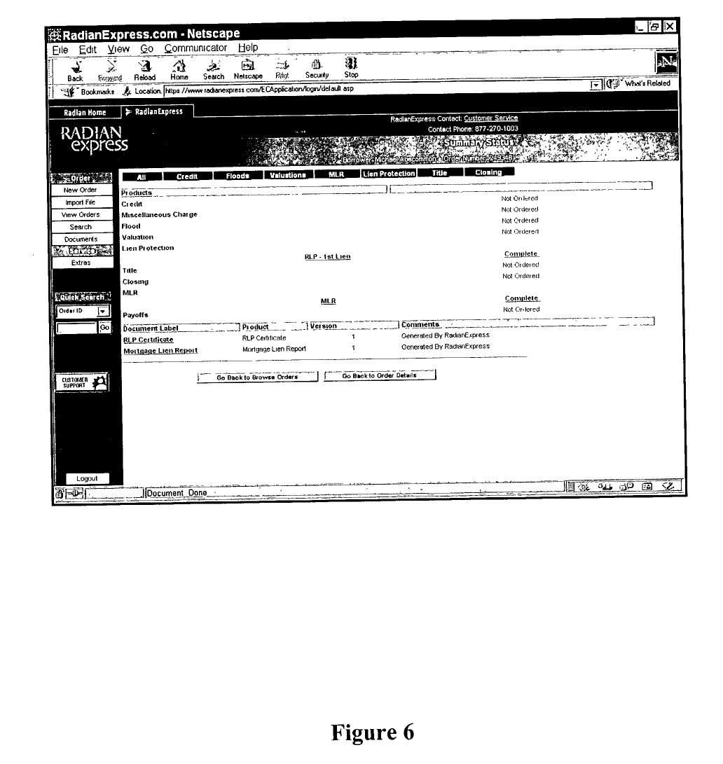

The order is then submitted, preferably by clicking on the Submit Order button. Thereafter, details of the order may be retrieved from Information Exchange System 13 in any number of ways, such as by clicking on the order ID on the current order form, or clicking the View Orders icon and selecting a particular order. This retrieves an order details form, such as the example shown in FIGS. 5(a)-(b). The order details form contains pertinent information about the order that was submitted via the order submission form previously described. Similarly, FIG. 6 shows an order status form that provides the lender and the borrower with information on the status of the production of the documents requested in the order.

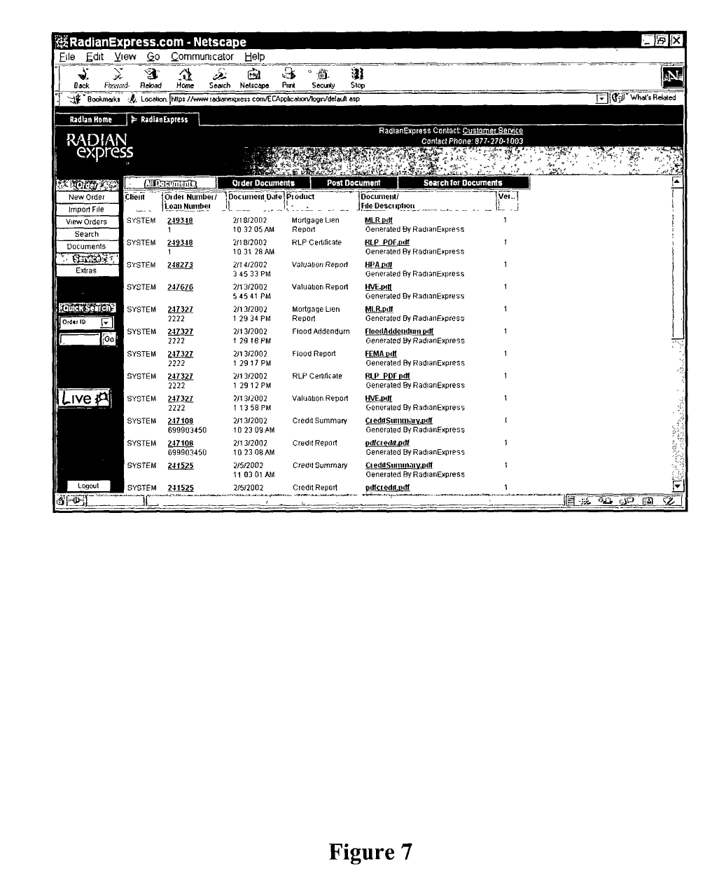

As noted above, the lender can order a variety of documents using the order submission form. Once these documents are complete, they can be downloaded from Information Exchange System 13 in a conventional manner, such as a file in .PDF format (although not limited thereto). FIG. 7 illustrates a documents form listing the various documents that have been selected for each order. This form may be accessed, for example, by clicking on the Documents icon on the menu bar. A particular document for an order can be downloaded simply by clicking on the appropriate link on the documents form.

In a preferred embodiment, the documents are prepared automatically and in real time by Information Exchange System 13. For example, once the loan related information has been submitted to Information Exchange System 13 by the lender using the order submission form, this information is preferably stored in Data Source 16. A software process operating on Web Server 14 in conjunction with Data Interface 15 in this embodiment then accesses this information and retrieves the desired information from Borrower Data Source 18 and Property Data Source 19. The retrieved information may then be stored in Data Source 16 as associated with the order ID for that order. When the user lender clicks on the link to retrieve the report, the Data Interface 15 retrieves the search result information from Data Source 16 and produces the report, which is returned to the user via Web Server 14. All of this can be accomplished using the aforementioned software programming in a conventional manner well known to those of ordinary skill in the art.

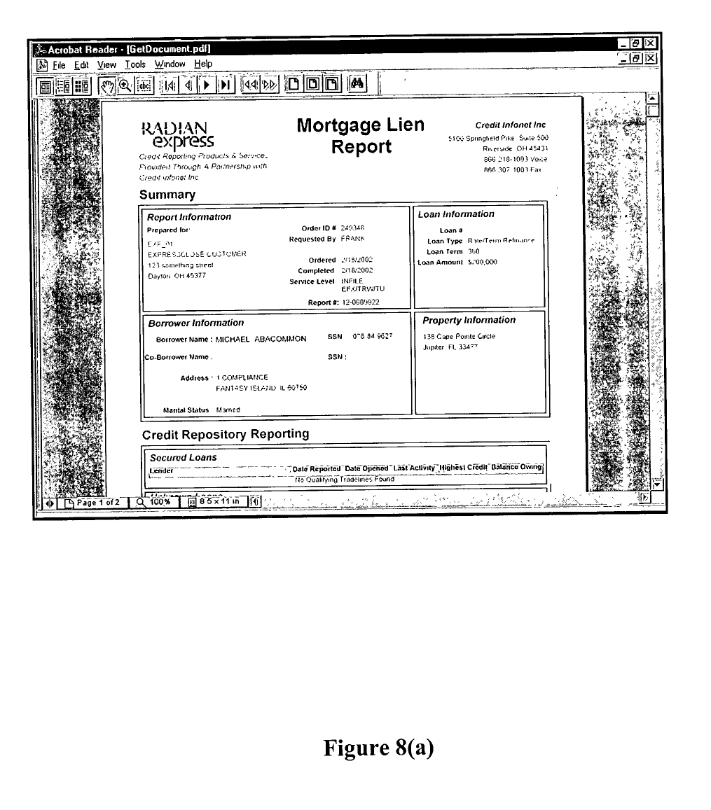

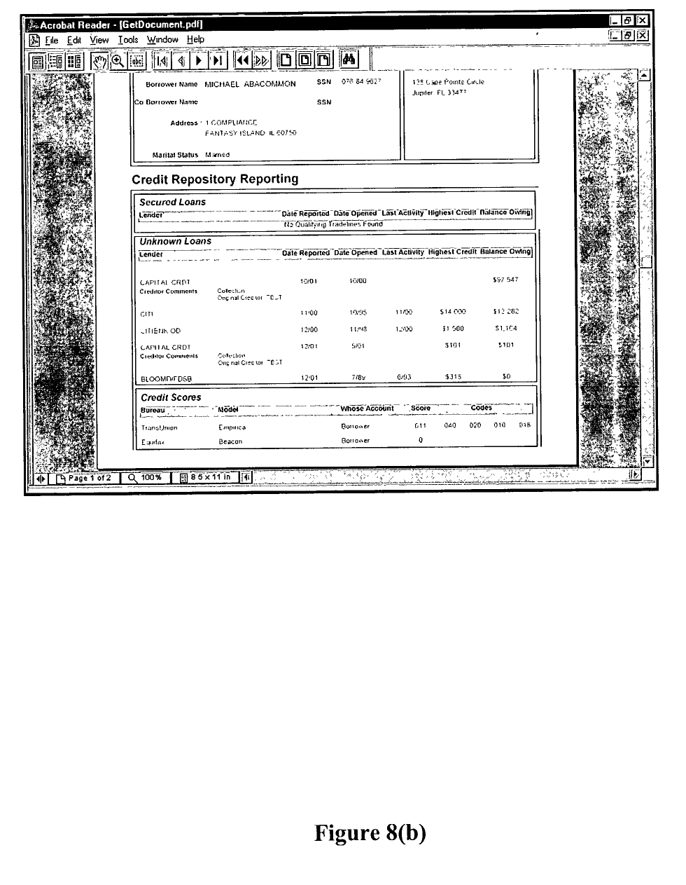

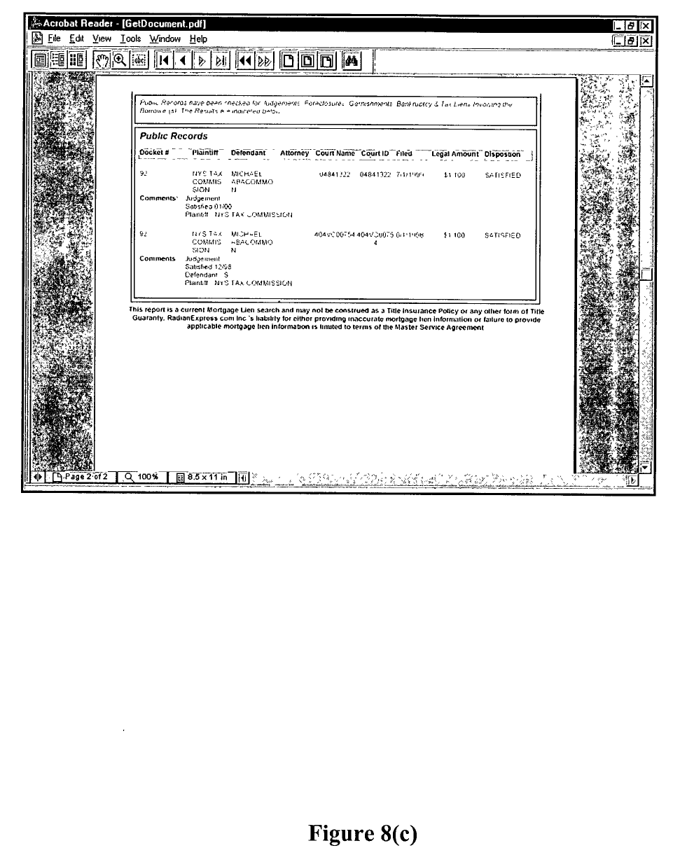

FIGS. 8(a)-(c) are computer screen shots illustrating a loan related search report in accordance with the invention. The report preferably contains information on the borrower, such as the borrower's credit history, as well as property related information, such as a mechanic's lien or other liens on the property, taxes, judgments and the like. When dealing with a second mortgage, this information will allow the lender and the insurer to properly evaluate the loan without the expense and complexity associated with title searches and title insurance.

Once the lender has reviewed the reports, and other appropriate documents, the lender approves or denies the loan application. If the loan is approved and meets the eligibility requirements for coverage under the policy, the lender notifies the insurer, who registers the loan under the policy. This may also be accomplished using Information Exchange System 13, such as through email communication via Email Server 17, although not limited thereto. Once the loan is registered, the lender has the required insurance to close the loan and the borrower has a simpler and less costly closing.

The invention provides many benefits to customers of lending institutions. Borrowers seeking loans from lenders enjoy decreased loan application fees, closing costs, insurance premiums and other fees, the ability to close loans within hours of applying for a loan, as well as improved access to the information used to complete their application. The process of providing access to the products used to complete a loan application keeps the borrower up to date, and educated, on their loan approval process. Ultimately, customers of lenders using the invention enjoy many of the benefits listed below.

Another benefit of the invention provides bundled products and services to mortgage lenders that allow them to save time and expense in processing of loan applications. The invention provides quick and easy access to credit reports, flood zone determinations, property valuations, ownership verifications, non-traditional closing services and recordation services.

The invention also has the benefit that it provides non-traditional signing services for lenders utilizing the suite of services. Non-traditional signing services take place at a time and location convenient to the borrower. The invention enables an agent in the field to meet a borrower to provide loan-signing services at their home, workplace, public location, or other pre-arranged location. This enables a borrower to set the time-schedule by which their loan is closed. Ultimately, customers of lenders are saved the traditional problems of having to meet at a title company or the lender's office to close their loan.

Moreover, many borrowers misplace the paper copy of the information that they obtained from the lender at closing. The invention has the significant advantage that it can provide a copy of the information used in the lending process and may be provided on electronic media for safe keeping by the borrower. Many times, this format even includes a copy of the signed and executed document after it has been recorded in the county courthouse. This process ensures that the borrower has easy access to this information in the event that there are any discrepancies relating to the loan. Copies of this information can be kept on file for years, so borrowers can rest assured that in the event the electronic copy is lost or misplaced, it can be replicated quickly and effectively.

Although this invention has been described with reference to particular embodiments, it will be appreciated that many variations may be resorted to without departing from the spirit and scope of this invention as set forth in the appended claims. For example, the embodiments disclosed herein incorporate separate data sources and a separate data interface and Web server, while one of ordinary skill in the art will appreciate that any number of, or only one, computer system is actually necessary to achieve the invention. Similarly, the software of the invention can comprise a single application having individual components or a suite of applications, and its form is not particularly limited. The invention can be implemented over the Internet, as described, or over a dedicated, closed network, or a VPN, for example.

What is claimed is:

1. A method of protecting a lender having a security interest in a real property against a loss arising from a default by a borrower on a loan for said real property, said method comprising the steps of:
covering said lender under an insurance policy to provide financial compensation for at least a portion of said loss arising from said default independently of the reason for the default;
providing a separate monetary limit for loan defaults involving one or more undisclosed liens on said property that secures said loan.

2. The method of claim 1, wherein said loss may further comprise one or more selected from the group consisting of damage to said property, destruction of said property, inability to use said property, and a drop in market value.

3. The method of claim 1, wherein said undisclosed lien on the property securing the defaulted loan comprises one or more selected from the group consisting of a mortgage lien, a mechanic's lien, a tax lien, and a judgment lien.

4. The method of claim 1, wherein said loan is limited to less than a predetermined amount, and there is a maximum LTV, or CLTV, ratio for said loan of a predetermined ratio.

5. The method of claim 1, wherein said insurance policy covers losses paid by said lender arising from a default on said loan subject to 1) an aggregate limit for loan default losses involving undisclosed liens on said property equal to a first predetermined number of basis points; and 2) an aggregate limit for loan default losses other than those involving undisclosed liens on said property equal to a second predetermined number of basis points.

6. The method of claim 1, wherein the following triggering events must occur for a claim to be made under said insurance policy: the borrower must default, said loss is incurred by said lender as a result of the default; said lender finds that the lender was in an inferior lien position upon foreclosure of the property securing the defaulted loan; said loss of said lender is settled if said lender suffers a loss because of said inferior lien position on the property securing the defaulted loan.

7. The method of claim 1, wherein said security interest in said property is a first lien and said loss arises from a loan default involving a valid undisclosed lien on the property securing the defaulted loan that takes priority over said first lien under said insurance policy, and wherein said portion of said loss to be covered under said insurance policy is the lesser of 1) said valid undisclosed lien, or 2) a standard loss calculation equal to the total of the amount of any unpaid principal balance, accumulated delinquent interest computed to the date of claim settlement, and advances made to said lender; less net proceeds upon an approved sale of said real property and any amount received by said lender under a primary mortgage guaranty insurance policy, said portion of said loss to be covered being subject to any limit on liability and other terms and conditions contained in said insurance policy.

8. The method of claim 1, wherein said security interest in said property is a second lien and said loss arises from a loan default involving a valid undisclosed lien on the property securing the defaulted loan that takes priority over said second lien under said insurance policy, and wherein said portion of said loss to be covered under said insurance policy is the lesser of 1) said valid undisclosed lien, or 2) a standard loss calculation equal to the sum of a predetermined percentage of any unpaid principal balance due to said lender under a loan as of the date of said default without capitalization of delinquent interest, penalties or advances, less the net proceeds of any sale of said real property payable to said lender, and less any amount received by said lender pursuant to any applicable policy of mortgage guaranty insurance; or the sum of a predetermined percentage of any unpaid principal balance due under a loan from said lender as of the date of said default, plus any accumulated delinquent interest computed to the date of claim payment at the rate of interest of said loan, plus foreclosure costs, including courts costs and reasonable attorney's fees, paid by said lender, less any net proceeds of any sale of said real property payable to said lender, and less any amount received by said lender pursuant to any other applicable policy of mortgage guaranty insurance, said portion of said loss to be covered being subject to any limit on liability and other terms and conditions contained in said insurance policy.

9. The method of claim 1, wherein said loan is selected from the group consisting of a rate/term refinance, a cash-out refinance, a home equity loan, or a home equity line of credit.

10. A method of protecting a lender having a security interest in a real property against a financial loss arising from a default by a borrower on a loan for said real property, said method comprising the steps of:
causing said lender to be covered under an insurance policy for a portion of said financial loss arising from said default independently of the reason for said default, wherein a separate monetary limit is provided for loan defaults involving one or more undisclosed liens on said property that secures said loan;
causing a loan to be generated between said lender and said borrower for at least a portion of said value of said real property; and
causing said loan to be associated with said insurance policy to trigger said insurance policy in the event of said default on said loan.

11. A method of protecting a lender having a security interest in a real property against a financial loss, wherein a loan is to be generated between a lender and a borrower for at least a portion of said value of said real property; said method comprising the step of:
causing an insurance policy to be issued by an insurer to said lender and covering said lender for a portion of said financial loss arising from a default on said loan;
providing a separate monetary limit for loan defaults involving one or more undisclosed liens on said property that secures said loan; and
requiring that a loan related search be conducted prior to covering said real property under said insurance policy, said loan related search including a review of both borrower related information and property related information.

12. An apparatus for protecting a lender having security interest in a real property against a loss arising from a default by a borrower on a loan for said real property, said apparatus comprising:
a means for covering said lender under an insurance policy to provide financial compensation for a portion of said loss arising from said default independently of the reason for the default; and
a means for providing separate monetary limit for loan defaults involving one or more undisclosed liens on said property that secures said loan.

13. The apparatus of claim 12, wherein said loss may comprise one or more selected from the group consisting of damage to said property, destruction of said property, inability to use said property, and a drop in market value.

14. The apparatus of claim 12, wherein said undisclosed lien on the property securing the defaulted loan comprises one or more selected from the group consisting of a mortgage lien, a mechanic's lien, a tax lien, and a judgment lien.

15. The apparatus of claim 12, wherein said loan is limited to less than a predetermined amount, and there is a maximum LTV, or CLTV, ratio for said loan of a predetermined ratio.

16. The apparatus of claim 12, wherein said insurance policy covers losses paid by said lender arising from a default on said loan subject to 1) an aggregate limit for loan default losses involving undisclosed liens on said property equal to a first predetermined number of basis points; and 2) an aggregate limit for loan default losses other than those involving undisclosed liens on said property equal to a second predetermined number of basis points.

17. The apparatus of claim 12, wherein the following triggering events must occur for a claim to be made under said insurance policy: the borrower must default, said loss is incurred by said lender as a result of the default; said lender finds that the lender was in an inferior lien position upon foreclosure of the property securing the defaulted loan; said loss of said lender is settled if said lender suffers a loss on the defaulted loan because of said change in lien priority.

18. The apparatus of claim 12, wherein said security interest in said property is a first lien and said default loss involves a valid undisclosed lien that takes priority over said first lien under said insurance policy, and wherein said portion of said loss to be covered under said insurance policy is the lesser of 1) said valid undisclosed lien on the property securing the loan, or 2) a standard loss calculation equal to the total of the amount of any unpaid principal balance, accumulated delinquent interest computed to the date of claim settlement, and advances made to said lender; less net proceeds upon an approved sale of said real property and any amount received by said lender under a primary mortgage guaranty insurance policy, said portion of said loss to be covered being subject to any limit on liability and other terms and conditions contained in said insurance policy.

19. The apparatus of claim 12, wherein said security interest in said property is a second lien and said default loss involves a valid undisclosed lien that takes priority over said second lien under said insurance policy, and wherein said portion of said loss to be covered under said insurance policy is the lesser of 1) said valid undisclosed lien on the property securing the defaulted loan, or 2) a standard loss calculation equal to the sum of a predetermined percentage of any unpaid principal balance due to said lender under a loan as of the date of said default without capitalization of delinquent interest, penalties or advances, less the net proceeds of any sale of said real property payable to said lender, and less any amount received by said lender pursuant to any applicable policy of mortgage guaranty insurance; or the sum of a predetermined percentage of any unpaid principal balance due under a loan from said lender as of the date of said default, plus any accumulated delinquent interest computed to the date of claim payment at the rate of interest of said loan, plus foreclosure costs, including courts costs and reasonable attorney's fees, paid by said lender, less any net proceeds of any sale of said real property payable to said lender, and less any amount received by said lender pursuant to any other applicable policy of mortgage guaranty insurance, said portion of said loss to be covered being subject to any limit on liability and other terms and conditions contained in said insurance policy.

20. The apparatus of claim 12, wherein said loan is selected from the group consisting of a rate/term refinance, a cash-out refinance, a home equity loan, or a home equity line of credit.

21. An apparatus for protecting a lender having a security interest in a real property against a financial loss arising from a default on a loan for said real property, said apparatus comprising:
means for causing said lender to be covered under a mortgage guaranty insurance policy for a portion of said financial loss arising from said default independently of the reason for said default, wherein a separate monetary limit is provided for loan defaults involving one or more undisclosed liens on said property that secures said loan;
means for causing a loan to be generated between said lender and said borrower for at least a portion of said value of said real property; and
means for causing said loan to be associated with said mortgage guaranty insurance policy to trigger said insurance policy in the event of said default on said loan.

22. An apparatus for protecting a lender having an interest in a real property against a loss wherein a loan is to be generated between a lender and a borrower for at least a portion of said value of said real property; said apparatus comprising:
means for causing said lender to be covered under a mortgage guaranty insurance policy for a portion of said loss arising from a default on said loan;
means for providing a separate monetary limit for loan defaults involving one or more undisclosed liens on said property that secures said loan; and
means for requiring that a loan related search be conducted prior to covering said real property under said mortgage guaranty insurance policy, said loan related search including a review of both borrower related information and property related information.
